(19) United States
(12) Patent Application Publication
(10) Pub. No.: US 2005/0225490 A1
(43) Pub. Date: Oct. 13, 2005

(54) Aerial having a dual antenna set and a lamp

(76) Inventor: Cheng-Si Wang, Changhua Hsien (TW)

Correspondence Address: DELLETT AND WALTERS, P. O. BOX 2786, PORTLAND, OR, 97208-2786, US

(21) Appl. No.: 10/671,972

(22) Filed: Sep. 25, 2003

(51) Int. Cl. H01Q 1/00

(52) U.S. Cl. 343/720

(57) ABSTRACT

A TV receiving aerial having a dual antenna set and a lamp is provided, including two antennas, a key pad, at least one light source, a lamp shade and a circuit board; wherein the light source is exposed over the unit body and engulfed by a lamp shade. The lamp can provide normal lighting and night light to facilitate the tuning of the TV receiving aerial. When the viewer turns on the lamp through the key pad control, the lamp driver circuit is enabled to supply DC current to the light source to give out light and brighten the surrounding area of the lamp shade. The TV receiving aerial is capable of receiving UHF and VHF channels, as well as cable channels through a cable switch.

### BACKGROUND OF THE INVENTION

1. Field of the Invention

The present invention relates to a multi-function TV signal receiving apparatus, in particular to a TV signal receiving aerial having a dual antenna set and a lamp.

2. Description of Related Arts

Households are commonly equipped with a TV signal receiving apparatus that is capable of receiving audio and video channels over a wide radio frequency (RF) range thus increasing the number of television channels selectable.

A typical TV receiving aerial (70), as shown in FIG. 7, is normally placed over a television set (80), having two antennas, one, in the form of a ring (72), for reception of ultra high frequencies (UHF) band, and the other, in the form of a straight rod (71), for reception of high frequencies (VHF) band. These two antennas are linked to the television (80) through special cables. The dual-antenna design of the TV receiving aerial (70) is to increase the audio and video channels receivable by the receiving aerial. Conventional TV receiving aerials only allow viewers to select channels 1-13 on the television set, but by using this dual antenna receiving aerial viewers will be able to select channels beyond the VHF frequencies.

The conventional TV receiving aerial can be a hindrance to normal body movement or an eyesore if the receiving aerial is not used in TV viewing. Since the TV receiving aerial has to be placed at a location close to or directly over the television set to remain physically connected, if the TV viewer does not select wireless channels, the receiving aerial is idle sitting on top of the television set and just taking up extra space.

The above mentioned TV receiving aerials with only a VHF band and limited functions will soon become obsolete.

### SUMMARY OF THE INVENTION

The primary object of the present invention is to provide a TV signal receiving aerial having a dual antenna set and a lamp, whereby the TV receiving aerial is not only able to receive audio and video signals over a wide RF range, but also has a lamp that can provide the necessary illumination when the viewer tries to operate the receiving aerial at night or in the darkness.

The basic structure of the TV signal receiving aerial comprises:
a unit body or antenna holder for supporting the dual antenna set;
at least one light source being installed on the unit body and exposed;
a lamp shade being mounted over the light source and attached to the unit body; and
a circuit board being embedded in the unit body, and interconnected by the dual antenna and the light source, which is comprised of a signal processing circuit and a lamp driver circuit.

The advantage of the present invention is that the viewer is able to use a key pad installed on the unit body to select either UHF or VHF channels for viewing. When the operation mode is set, the audio video signals are received from the respective antennas, and then passed to the circuit board for conversion to an appropriate format, and finally output through the audio and video terminals to a television set for broadcasting to the viewer.

Another advantage of the invention is that the antenna holder is built in with a lamp. When the viewer activates the lamp through the key pad control, the circuit board enables the lamp driver circuit, which provides a stable DC current to the light source to turn on the lamp. The addition of a lamp to the receiving aerial can increase the functional value of an existing product.

The secondary object of the present invention is to provide an aesthetically designed antenna holder that incorporates a dual antenna set and a lamp, such that the lamp shape and the ring antenna are fully integrated without increasing the actual size of the receiving aerial or antenna holder.

The lamp shade in the form of a cylinder is installed upright on the base having a bevel opening at the top. The lamp shade has to be inserted through the hollow space of the ring antenna and mounted on a rotatable stand, which can be rotated for adjustment of the antenna position for signal reception. Since the lamp shade and the ring antenna are installed on the rotatable stand coaxially, the lamp shade can also be adjusted by appropriately rotating the switch stand.

Alternatively, the lamp shade can be shaped like a water drop or in an oval shape, coinciding with the shape of the ring antenna, whereby the rim of the ring antenna can be permanently attached on the outer edge of the lamp shade. The integration of the lamp shade and the ring antenna on the existing antenna holder can create an aesthetic impression.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view on one preferred embodiment of the invention;

FIG. 2 is a schematic diagram of the signal processing circuit of the invention;

FIG. 3 is a schematic diagram of the lamp driver circuit of the invention;

FIG. 4 is another preferred embodiment of the invention;

FIG. 5 is a conceptual diagram of the path of movement of the adjustable antenna and the lamp shade originally shown in FIG. 4;

FIG. 6 is a diagram of the TV receiving aerial, in accordance with the invention, being placed on a television set; and

FIG. 7 is a diagram of a conventional TV receiving aerial placed on a television set.

### DETAILED DESCRIPTION OF THE PREFERRED EMBODIMENT

The present invention provides a TV signal receiving aerial having a dual antenna set and a lamp built into the antenna holder. The integration of the lamp and the antenna is unique in that the lamp shade is fully integrated with the ring antenna without increasing the actual size of the TV receiving aerial or the antenna holder.

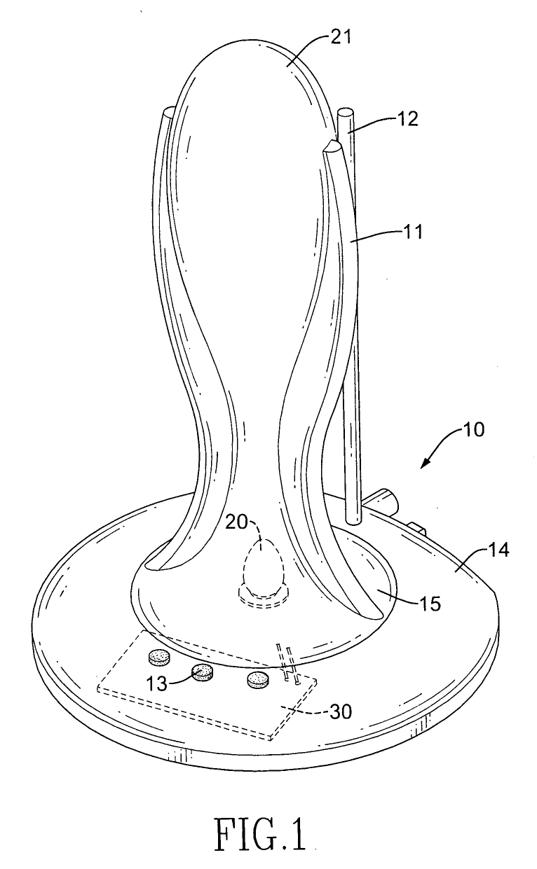

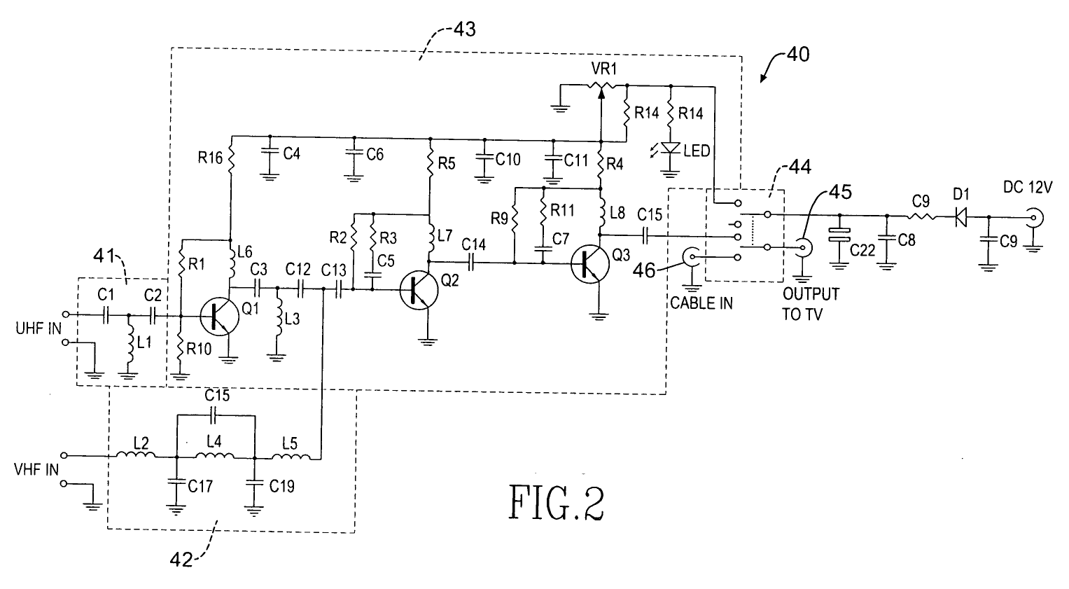

The basic structure of the TV receiving aerial having a dual-antenna construction and a lamp, as implemented by one embodiment of the invention, is shown in FIG. 1, comprising a unit body or antenna holder (10), a ring antenna (11), a straight antenna (12), a key pad (13), a base (14), a rotatable stand (15), a light source (20), and a circuit board (30), wherein
the unit body or antenna holder (10) has the ring antenna (11), the straight antenna (12), the key pad (13), the base (14) and the rotatable stand (15) mounted thereon;
the ring antenna (11) is mounted on the rotatable stand (15), such that the ring antenna (11) can be rotated in step with the rotatable stand (15) for selection of audio video channels for best reception (in the present embodiment the ring antenna (11) is fixed along the circular rim of a lamp shade (21));
the rotatable stand (15) is mounted at the center of the antenna holder and surrounded by the base (14);
the straight antenna (12) is either mounted on the rotatable stand (15) or fixed on the base (14); (in the present embodiment the straight antenna (12) is held on the base (14) in a fixed position);
the key pad (13) is installed on the base (14) of the unit body (10), through which the signal reception can be switched between wireless channels or cable channels, and the lamp can be controlled;
at least one of the light source (20) is installed at a position exposed over the base (14), which can be a light bulb or a light emitting diode (LED) (in the present embodiment the light source (20) is installed at the base of the rotatable stand (15));
the lamp shade (21), shaped like a water drop or oval shaped, is also installed on the rotatable stand (15) or the base (14) for directing the light beam from the light source (20) (in the present embodiment the lamp shade is mounted on the rotatable stand (15));
the circuit board (30) is received in the unit body (10) and connected to the straight antenna (12), ring antenna (11), the light source (20) and the key pad (13), which is comprised of a signal processing circuit (40) and a lamp driver circuit (50);
the signal processing circuit (40) is formed by other components as shown in FIG. 2 including:
   a high pass filter (41) being connected to the ring antenna (not shown in diagram) to remove low frequency noise from the UHF signals received by the TV receiving aerial;
   a band pass filter (42) being connected to the straight antenna to extract VHF signals received therefrom;
   a signal amplifier (43) being respectively connected to the output of the high pass filter and the band pass filter (41) (42) to amplify the audio video signals received by the antennas to produce the required audio and video outputs;
   a cable switch (44) being connected to the output of the signal amplifier (43), a cable connector port (46) and an AV terminal (45) for switching the signal reception between wireless channels or cable channels.

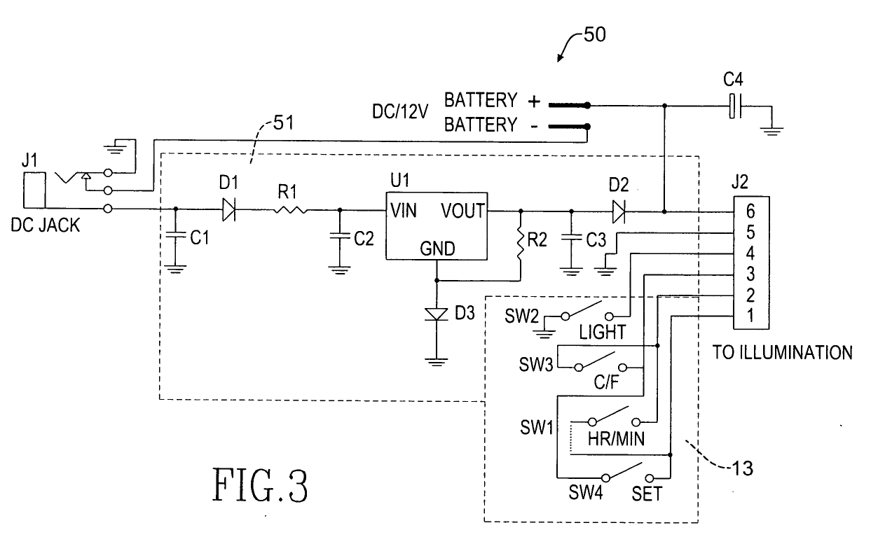

The lamp driver circuit (50), as shown in FIG. 3, is formed by a voltage regulator (51), where the input of the voltage regulator (51) comes from the DC power supply, and the output through the key pad (13) control is connected to the power of the light source (not shown in the diagram) for providing a stable DC current; where the key pad (13) has a power switch to provide the necessary control for turning on the light source.

The lamp can be activated by the key pad control (13). When the lamp is on, the lamp driver circuit (50) embedded in the circuit board (30) delivers DC power to the light source (20) causing the light source (20) to give out light, which strikes against the lamp shade (21) and brightens the surrounding area of the lamp shade (21), thus providing the background lighting for tuning the receiving aerial.

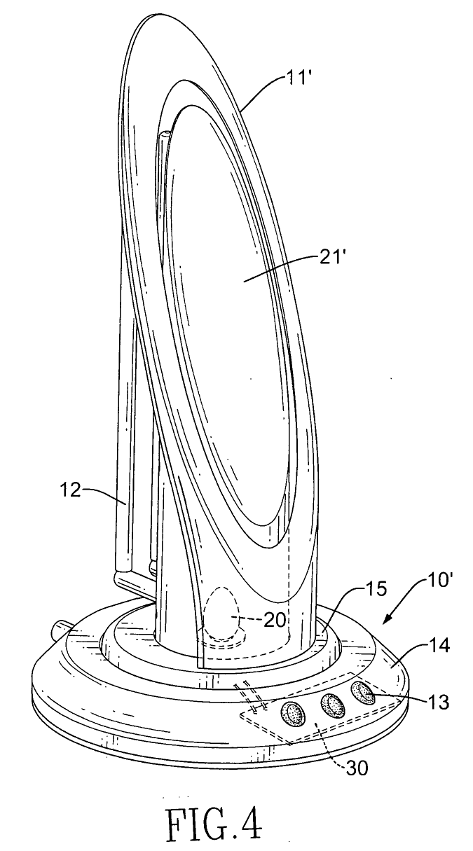

In another embodiment of the invention, as shown in FIG. 4, the unit body or antenna holder (10′) has a ring antenna (11′), a straight antenna (12), a base (14), a rotatable stand (15), a key pad (13), a light source (20) and a lamp shade (21′).

The form and position of all but two of the above components are the same as those in the previous example, with the exception of the ring antenna (11′) and the lamp shade (21′) wherein
the ring antenna (11′) is fixed at a slant on the rotatable stand (15), such that the ring antenna (11′) can be rotated in step with the rotatable stand (15) for selection of audio video channels; and
the lamp shade (21′) is positioned at the center of the unit body or antenna holder (10) in the form of a cylinder surrounding the light source (20), with the top opening beveled, whereby the lamp shade (21′) is mounted through the central space of the ring antenna (11′) and fixed on the unit body (10), having the inclined angle of the ring antenna (11′) to correspond with the beveled opening of the lamp shade (21′), and the external form of the lamp shade (21′) to mesh in with the ring antenna (11′).

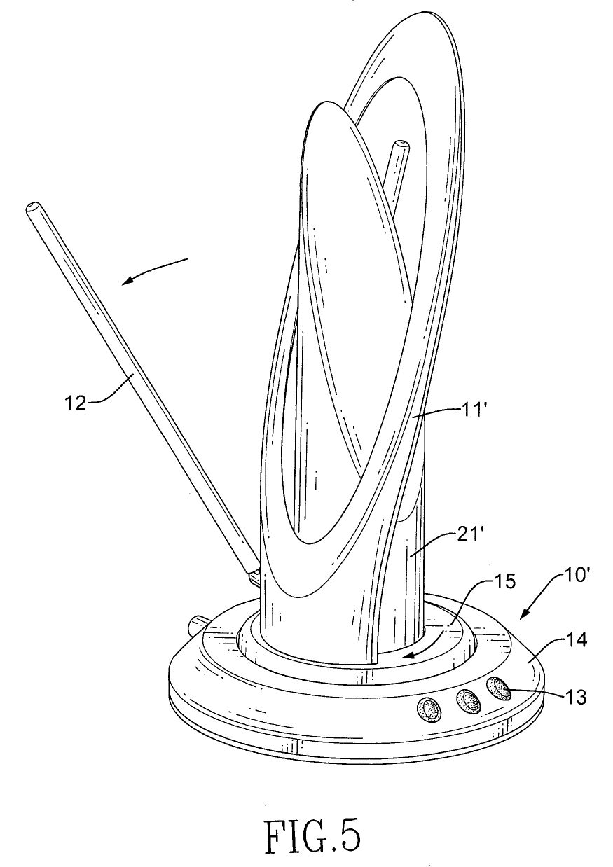

When the rotatable stand (15) rotates around an axle, as shown in FIG. 5, the ring antenna (11′) surrounding the lamp shade (21′) also turns around in step with the movement of the rotatable stand (15).

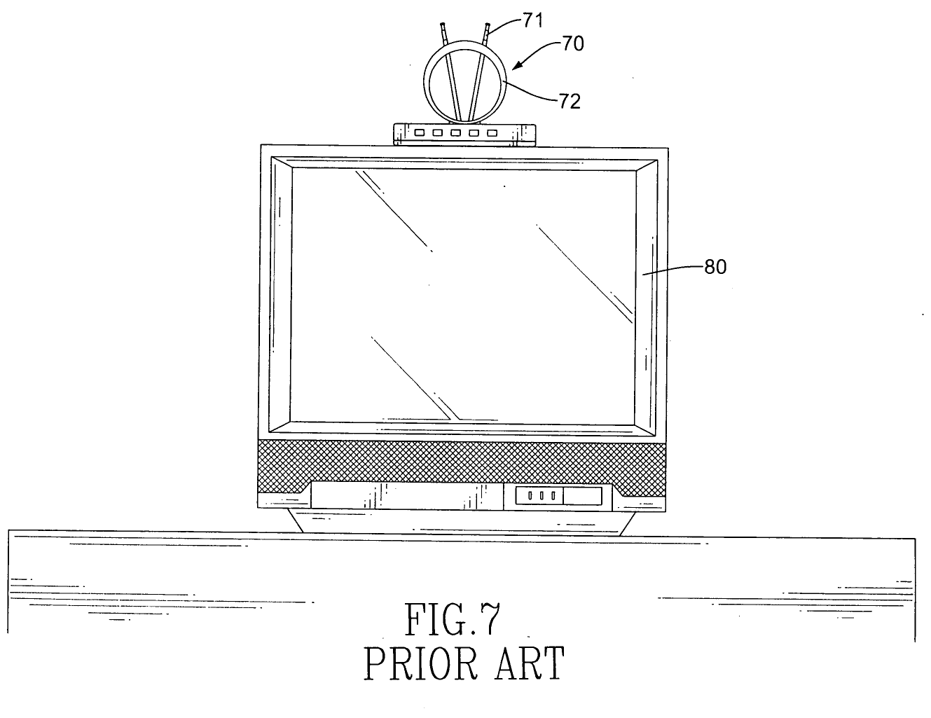

When compared with conventional receiving aerials, as shown in FIG. 7, that could only receive wireless channels, the present invention is clearly a more advanced design in that the TV signal receiving apparatus is able to receive both wireless and cable channels, and the antenna holder also incorporates a lamp to facilitate channel tuning under the night light.

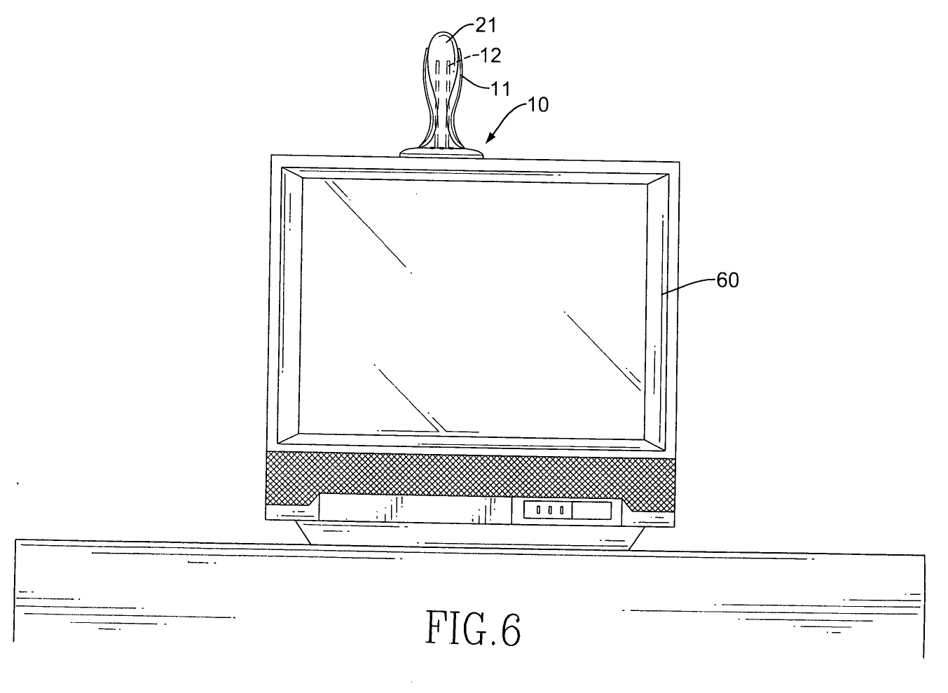

Furthermore, the present design has integrated a lamp and a dual antenna set in the antenna holder without increasing the actual size of the TV receiving aerial, as shown in FIG. 6. The TV receiving aerial can be posed as an artistic decoration over a television set (60), and is not just a household appliance.

The foregoing description of the preferred embodiments of the present invention is intended to be illustrative only and, under no circumstances, should the scope of the present invention be so restricted, and changes may be made in detail, especially in matters of shape, size, and arrangement of parts within the principles of the invention to the full extent indicated by the broad general meaning of the terms in which the appended claims are expressed.

1. A TV signal receiving aerial having a dual antenna set and a lamp, comprising:
a unit body, having a ring antenna, a straight antenna and a key pad mounted thereon;
at least one light source installed on the unit body and exposed;
a lamp shade mounted on the unit body and surrounding the at least one light source;
a circuit board received in the unit body and interconnected with the straight antenna, ring antenna, at least one light source and the key pad, wherein the circuit board is comprised of a signal processing circuit and a lamp driver circuit.

2. The TV receiving aerial as claimed in claim 1, wherein the signal processing circuit includes:
a high pass filter being connected to the ring antenna to remove low frequency noise from the signals received by the ring antenna;
a band pass filter being connected to the straight antenna to extract the VHF signals from the straight antenna; and
a signal amplifier being connected to the output of the high pass filter and band pass filter to amplify the signals before outputting the audio and video signals to the television.

3. The TV receiving aerial as claimed in claim 2, wherein the signal processing circuit further includes a cable switch connected respectively to a signal processing unit, a AV terminal and a cable connector port for switching the reception between wireless channels and cable channels.

4. The TV receiving aerial as claimed in claim 1, wherein the lamp driver circuit is formed by a voltage regulator, being connected between a DC power source and the power input of the light source through the key pad.

5. The TV receiving aerial as claimed in claim 2, wherein the lamp driver circuit is formed by a voltage regulator, being connected between a DC power source and the power input of the light source through the key pad.

6. The TV receiving aerial as claimed in claim 3, wherein the lamp driver circuit is formed by a voltage regulator, being connected between a DC power source and the power input of the light source through the key pad.

7. The TV receiving aerial as claimed in claim 1, wherein the light source is a light bulb.

8. The TV receiving aerial as claimed in claim 2, wherein the light source is a light bulb.

9. The TV receiving aerial as claimed in claim 3, wherein the light source is a light bulb.

10. The TV receiving aerial as claimed in claim 1, wherein the light source is a light emitting diode (LED).

11. The TV receiving aerial as claimed in claim 2, wherein the light source is a light emitting diode (LED).

12. The TV receiving aerial as claimed in claim 3, wherein the light source is a light emitting diode (LED).

13. The TV receiving aerial as claimed in claim 1, wherein the unit body further includes a base and a rotatable stand, wherein:
the base is fixed on the unit body with the key pad mounted thereon; and
the rotatable stand is mounted on the base with the ring antenna fixed thereon.

14. The TV receiving aerial as claimed in claim 13, wherein the light source and the lamp shade shaped like a water drop or in oval shape, are respectively mounted on the rotatable stand coaxially, and the outer edge of the lamp shade is fixed on the rim of the ring antenna, such that the beveled lamp shade is fully integrated with the ring antenna in external appearance.

15. The TV receiving aerial as claimed in claim 13, wherein the light source and the lamp shade, in cylindrical shape, are respectively mounted on the base, and the lamp shade is inserted through the central space of the ring antenna and fixed on the unit body, with the top end beveled and open to the outside, such that the slant angle of the ring antenna corresponds with the slanted opening of the lamp shade.
